(19) United States
(12) Patent Application Publication
(10) Pub. No.: US 2021/0349982 A1
(43) Pub. Date: Nov. 11, 2021

(54) SERVICE KIOSK DEVICE PROVISIONING

(71) Applicant: Hewlett-Packard Development Company, L.P., Spring, TX (US)

(72) Inventors: Matthew Frederickson, Boise, ID (US); Kyle J. Nottingham, Boise, ID (US); Gerold K. Shelton, Boise, ID (US)

(21) Appl. No.: 16/481,473

(22) PCT Filed: Apr. 30, 2018
(86) PCT No.: PCT/US2018/030289

§ 371 Date: Jul. 28, 2019

(51) Int. Cl. G06F 21/35; G07C 9/22; G06Q 10/00; G06F 16/23

(52) U.S. Cl. CPC G06F 21/35; G07C 9/22; G06F 16/2365; G06F 16/2358; G06Q 10/20

(57) ABSTRACT

Examples associated with service kiosk device provisioning are described. One example includes receiving at a service kiosk, authentication data associated with a user, data associated with a first device currently assigned to the user, a device specification for a second device to be provided to the user, and provisioning data for the second device. A selected device is selected based on the device specification to serve as the second device. The selected device is selected from a set of devices stored in compartments of the service kiosk and operably connected to the service kiosk. The selected device is configured based on the provisioning data. At a physical interface of the service kiosk, a credential that matches the authentication data associated with the user is received. Physical access is provided to a first compartment into which the user is to store the first device. Physical access is provided to a second compartment from which the user is to retrieve the second device.

### BACKGROUND

Computing devices today have become a fundamental part of the way we live and work, as well as smaller and more mobile. Individuals, for example, use computers and mobile devices for entertainment, communication, shopping, and so forth. Further, businesses often provide computers for their employees so that the employees can efficiently carry out their duties across a wide variety of functions. While some businesses take on ownership and maintenance of devices provided to their users, other companies may opt to offload certain information technology costs using a variety of techniques. For example, some companies may rely on a device-as-a-service (DAAS) offering. A DAAS offering may involve periodic payments to a device provider in exchange for user devices and service guarantees for the hardware, software, and so forth, of the devices.

### BRIEF DESCRIPTION OF THE DRAWINGS

The present application may be more fully appreciated in connection with the following detailed description taken in conjunction with the accompanying drawings.

FIG. 1 illustrates an example service kiosk associated with service kiosk device provisioning.

FIG. 2 illustrates a flowchart of example operations associated with service kiosk device provisioning.

FIG. 3 illustrates another flowchart of example operations associated with service kiosk device provisioning.

FIG. 4 illustrates another example service kiosk associated with service kiosk device provisioning.

FIG. 5 illustrates an example computing device in which example systems, and methods, and equivalents, may operate.

### DETAILED DESCRIPTION

Examples associated with receptacle isolation are described. As will be more fully described herein, a service kiosk is an apparatus that is meant to store a set of devices for supporting a device-as-a-service model. The service kiosk includes a set of compartments each fitted with connectors to provide a connection between a device stored within the compartment and various control modules embedded in the service kiosk. The service kiosk may be physically installed in a location accessible to employees of a company relying on a device-as-a-service model to provide electronic devices to its employees. When service events associated with devices occur, the employees may visit the kiosk to have their device repaired by the kiosk and/or replaced by backup devices stored in the kiosk. This may increase the uptime of devices assigned to the employees. The backup devices may also reduce support costs associated with sending out technicians to provide support as a device failure can be at least temporarily mitigated by replacing the failed device with a new device in the kiosk, until eventually, a technician can be sent out to efficiently service or replace many devices stored in the kiosk in a single visit.

This disclosure covers the process by which the service kiosk may replace a device assigned to a user. The service kiosk may receive provisioning data associated with the user, in addition to a device specification. Based on the device specification, the kiosk may select a device stored in a compartment of the kiosk. The kiosk may then configure the device based on the provisioning data. When the user arrives at the kiosk to pick up the new device, the kiosk may authenticate the user, grant access to a compartment into which the user may place their old device, and then grant access to a compartment from which the user may retrieve the newly configured device. Various life cycle events may be appropriate for this type of device replacement. For example, device replacement may be appropriate for a failed device, when the user upgrades the service level of the device assigned to them, after a predetermined service period for the user's old device, and so forth.

It is appreciated that, in the following description, numerous specific details are set forth to provide a thorough understanding of the examples. However, it is appreciated that the examples may be practiced without limitation to these specific details. In other instances, methods and structures may not be described in detail to avoid unnecessarily obscuring the description of the examples. Also, the examples may be used in combination with each other.

“Module”, as used herein, includes but is not limited to hardware, firmware, software stored on a computer-readable medium or in execution on a machine, and/or combinations of each to perform a function(s) or an action(s), and/or to cause a function or action from another module, method, and/or system. A module may include a software controlled microprocessor, a discrete module, an analog circuit, a digital circuit, a programmed module device, a memory device containing instructions, and so on. Modules may include gates, combinations of gates, or other circuit components. Where multiple logical modules are described, it may be possible to incorporate the multiple logical modules into one physical module. Similarly, where a single logical module is described, it may be possible to distribute that single logical module between multiple physical modules.

As used herein, a service kiosk is intended to broadly describe a category of apparatuses used to securely store electronic devices in a manner that allows the devices to be configured while stored in the service kiosk. The service kiosk may have one or more compartments having data and/or power connectors. Devices that are attached to the data connectors may be configured either directly by the service kiosk or remotely by a remote service. Depending on where the devices are in their life cycle, the configuration may include setting up a device for a new user, modifying the device on behalf of a current user (e.g., reconfiguring the device, repairing the device), deprovisioning a device, and so forth. The service kiosk may also include an interface for communicating with and/or authenticating users. Once authenticated, the service kiosk may grant the user access to devices and or compartments to allow the user to perform a task related to a device assigned to the user. The task may involve obtaining a device from the kiosk, storing a device in the kiosk, and so forth. In various examples, the service kiosk may resemble, for example, a vending machine, a set of lockers, a chest of drawers, and so forth. Various structural components of a service kiosk may be made from wood, metal, plastic, or other suitable materials. The service kiosk may include structural elements such as legs, supports, wall fasteners, and so forth.

Consequently, the service kiosk may facilitate fulfilling service guarantees of a device-as-a-service (DAAS) offering. In a DAAS offering, a user or business may periodically pay a device provider for a device and a promise to service the device in the event the device fails. The service guarantee may include a variety of terms and in various examples may cover firmware, software, hardware, device data, user data, periodic lifecycle upgrades, and so forth. In this example, ownership of the device may remain with the device provider. In the event of a failure of the device or some other technical issue related to the device, a service kiosk stationed in a location accessible to the user may allow the device provider to more easily provide technical support for the device, up to and including replacing the device with a working device. For businesses that are relying on several devices at any given time, it may be cost effective for the business to have an on-site service kiosk to be able to quickly provision a new device for a new user, deprovision a device when that device's user leaves the business, and so forth, in addition to the technical support features that may be facilitated by the service kiosk itself. Eventually, when it is determined that the state of the devices in the service kiosk make it likely the service kiosk will begin failing to fulfil the service guarantee to the business (e.g., because the service kiosk is full, empty, has a number of devices in need of repair, or a combination of factors) a technician may be called to service the kiosk and/or devices stored within. This may be less expensive to the business and/or the device provider than having a technician on site, or having a technician called to service each malfunctioning device.

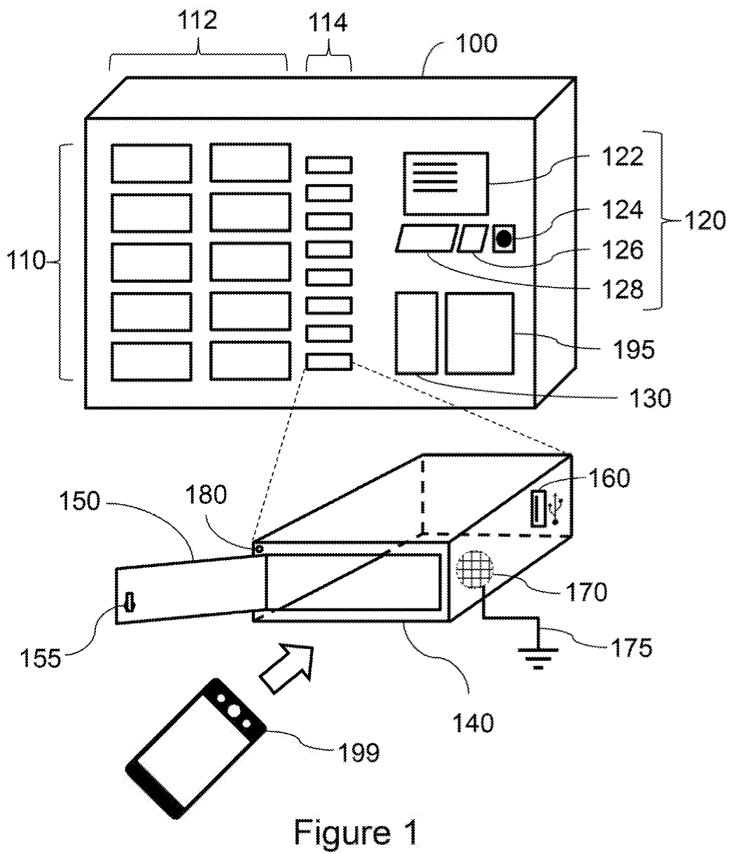

FIG. 1 illustrates an example service kiosk 100 associated with receptacle isolation. Service kiosk 100 includes a set of receptacles 110. While 18 receptacles are shown, in other examples, service kiosk 100 may include a greater or lesser number of receptacles. The receptacles 110 may be adapted for storing electronic devices 199. Different receptacles may be adapted to store different types of electronic devices 199. Here for example, receptacles 112 may be adapted to store a first type of device (e.g., laptops), and receptacles 114 may be adapted to store a second type of device (e.g., cell phones). In other examples, receptacles may be configured to store different types, models, and/or brands of laptops, phones, tablets, or other device types. Receptacles 110 may be adapted to store different types of devices based on a variety of attributes. For example, receptacles 110 for storing phones may be smaller than receptacles 110 for storing laptops.

One receptacle 140 is illustrated in additional detail to further illustrate features of receptacles 110. In this example, receptacle 140 is adapted for storing cellular phones 199. This may affect the size of receptacle 140, connectors 160 installed in receptacle 140, and so forth. Here, receptacle 140 is shown as having a universal serial bus (USB) connector 160. USB connector 160 may provide power to device 199 as well a data connection between device 199 and other components of service kiosk 100. For laptops, receptacles 110 may use a different configuration of connectors 160 for providing power and/or data to a device 199. For example, a regional power adaptor may be used for providing power to devices. The data connection for a laptop may be provided using, for example, an ethernet port, a universal serial bus port, or other types of ports.

It is also worth observing that in other examples, connector 160 may take different physical forms. Here, connector 160 is illustrated as a USB port in the rear wall of receptacle 140. This may mean that to connect device 199 to connector 160, an appropriate cable would also need to be provided. In other examples, connectors 160 may be cables or retractable cables of the appropriate type for connecting to a device type for which receptacle 140 is configured, a docking port of the appropriate type for connecting to a device type for which receptacle 140 is configured, a wireless communication transmitter (e.g., WIFI, Bluetooth) and so forth. The different connector types may have different tradeoffs. For example, a USB port as illustrated may ensure that a device appropriate cable is provided to a user who obtains a device from receptacle 140, but would also mean that a user inserting a device 199 would have to bring or be provided such a cable. Alternatively, a connector that involves an installed cable or docking port may ensure that a person inserting a device into receptacle 140 would be able to insert the device without providing an additional cable, but would mean that a user retrieving a device from receptacle 140 would have to be provided an appropriate cable through an alternative method.

Receptacle 140 also includes a locking mechanism 155. In this example, locking mechanism 155 is illustrated as being attached to a door 150 of receptacle 140. However, locking mechanism 155 may take a variety of forms and its form may depend on the form by which door 150 is designed to give access to users. Here for example, door 150 is illustrated as opening outwards, though in other examples, a sliding, rotating, or retracting door may be appropriate. Locking mechanism 155 may be controllable by other components of service kiosk 100 to grant and restrict access to receptacle 140. These other components and the situations in which access to receptacle 140 may be controlled are more fully discussed below. In some examples, it may also be desirable for locking mechanism 155 to be controllable via a physical mechanism (e.g., a service key). This may allow receptacle 140 to be serviced by a technician to, for example, modify the contents of receptacle 140, repair a component of receptacle 140, and so forth, even when service kiosk 100 is unpowered.

In this example, receptacle 140 is illustrated as incorporating a digital isolator 170. Here, digital isolator 170 is illustrated as a faraday cage 170 that is built into the structure of receptacle 140. Faraday cage 170 may prevent wireless electronic signals from being transmitted by device 199 to devices external to receptacle 140, as well as preventing device 199 from receiving wireless signals from devices external to receptacle 140. In this example, faraday cage 140 is illustrated as being grounded 175, though in other examples, the ground may be excluded. Other digital isolation techniques may also be employed. For example, digital isolation may also be achieved via the port 160 providing a data connection between device 199 and other components of service kiosk 100. By way of illustration service kiosk 100 may implement individualized networks to prevent direct transmission of wired signals between devices in members of the set of receptacles 110. This may also prevent devices 199 from detecting whether other devices are connected to service kiosk 100. Digital isolation may also include signal isolation to ensure secure communication between devices in the receptacles 110 and other components of service kiosk 100. In some examples, digital isolation may also incorporate power isolation.

Service kiosk 100 also includes an interface 120. Interface 120 may include several components. Here interface 120 includes a display 122, a keyboard 128, a keypad 126, and a radio frequency identification (RFID) scanner 124. Interface 120 may use these components to facilitate communicating with user interacting with service kiosk 100. Interface 120 may also include additional components including for example, cameras, touch input devices, external device connectors (e.g., to provide power and/or data to devices not in receptacles 110), and so forth. Interface 120 may also make use of lights 180 associated with individual receptacles 110. These lights 180 may allow the interface to direct a user to a specific receptacle 110 of service kiosk 100. For example, when service kiosk 100 seeks to direct a user to a specific receptacle 110, service kiosk 100 may control a light on that receptacle to turn on, blink, and so forth.

Service kiosk 100 may also include a variety of modules 130 for performing various functions associated with service kiosk 100 and/or configuring devices 199 stored in compartments 110 of service kiosk 100. Modules 130 may be, for example, performed by a processor of a computer embedded in service kiosk 130. In other examples, modules 130 may act as a communication pass through for communications between a remote information technology module (e.g., a device-as-a-service operation) and devices 199 stored in compartments 110 of service kiosk 100.

In various examples, the modules 130 may interact with a user via interface 120, with devices 199 in compartments 110, with other modules 130, and with remote servers and/or devices. For example, modules 130 may include an authentication module. The authentication module may receive a credential from a user and authenticate the credential based on authentication data associated with the user. The authentication data may have been received from a remote information technology module. When the user is successfully authenticated, the authentication module or another module 130 of service kiosk 100 may grant the user access to one or more receptacles 110 of service kiosk 100. The user may provide the credential via user interface 120. The credential may be, for example, a username and password pair that identifies the user that the user inputs via keyboard 128. In another example, the credential may be an RFID signal the user provides via RFID scanner 124. In another example, the user may authenticate themselves by attaching the mobile device 199 to a data connector of service kiosk 100. Multi-factor authentication may also be appropriate involving a combination of the above and/or other authentication techniques.

In various examples, service kiosk 100 may be selective about granting user access to receptacles 110. How service kiosk 100 determines which receptacles 110 to which a user is granted access may depend on what function service kiosk 100 is performing for the user. In various examples, the user may be picking up a device from service kiosk 100, storing a device in service kiosk 100, having a device repaired or configured by service kiosk 100, diagnosing a technical issue with a device with the help of service kiosk 100, and so forth. In these examples, service kiosk 100 may grant such a user access only to receptacles associated with the task being performed by service kiosk 100. The user may be granted access to these receptacles 110 by service kiosk 100 controlling locking mechanisms 155 on the respective receptacles 110. In cases where the user is a technician responsible for servicing service kiosk 100, the user may be granted access to specific receptacles, or in some cases general access to all receptacles 110. This may allow the technician to adjust the contents of the receptacles and/or perform physical maintenance on devices stored within service kiosk 100 or on service kiosk 100 itself.

Service kiosk 100 may also include a variety of other components 195. For example, component 195 may be a compartment storing additional supplies that support the purpose of service kiosk 100. By way of illustration, component 195 may store spare parts, extra data and/or power cables, and so forth that may be used by users interacting with service kiosk 100. In other examples, component 195 may also store, for example, packaging and mailing supplies for shipping devices 199 for service. Other potential components 195 may also be contemplated.

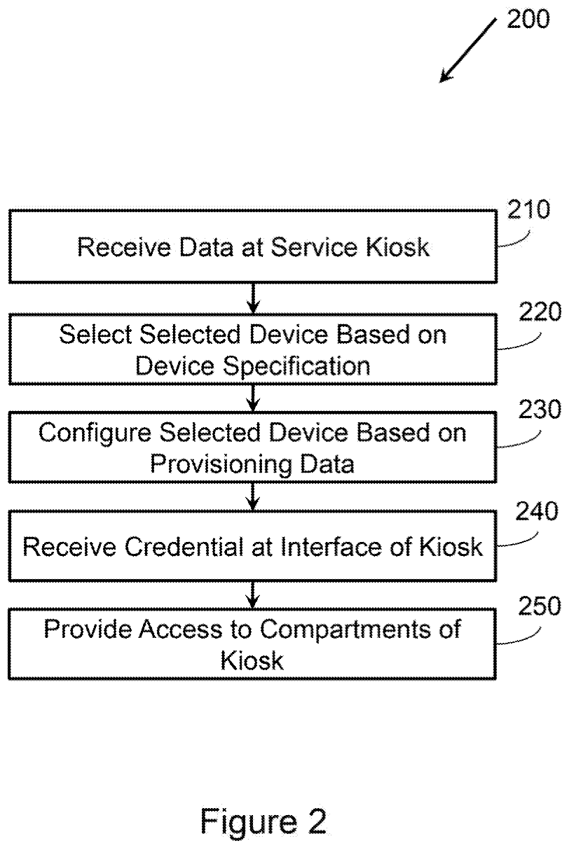

FIG. 2 illustrates an example method 200. Method 200 may be embodied on a non-transitory processor-readable medium storing processor-executable instructions. The instructions, when executed by a processor, may cause the processor to perform method 200. In other examples, method 200 may exist within logic gates and/or RAM of an application specific integrated circuit (ASIC).

Method 200 may perform various tasks associated with service kiosk device provisioning. Method 200 includes receiving data at a service kiosk at 210. The data may include authentication data associated with a user, data associated with a first device currently assigned to the user, a device specification for a second device to be provided to the user, and provisioning data for the second device. In one example, this data may be received at the service kiosk in response to a failure of the first device. In another example, the data may be received at the service kiosk in response to a life cycle event associated with the first device.

Method 200 also includes selecting a selected device at 220. The selected device is selected based on the device specification. The selected device may be selected from a set of devices stored in compartments of the service kiosk and operably connected to the service kiosk. The device specification may specify, for example, a specific device stored in the service kiosk (e.g., based on an identifier of the device, based on a compartment of the service kiosk), a device type, a set of attributes associated with the device (e.g., storage space, processing power, size), and so forth. When the device specification specifies a set of attributes, the service kiosk may use a matching process to identify a best fit device stored in the service kiosk. The matching process may, for example, use a set of rules to select a device that fits the attributes without unnecessarily exceeding the device specification.

Method 200 also includes configuring the selected device at 230. The selected device may be configured according to the provisioning data. The provisioning data may include, for example, applications to be installed on the selected device, settings associated with the user, data retrieved from the first device, and so forth. Thus, configuring the selected device may include installing these applications on the selected device, applying the settings to the selected device, storing data retrieved from the first device to the selected device, and so forth. In some examples, the provisioning data may have been retrieved from a device previously assigned to the user. In this example, the provisioning data may be used to configure the selected device to have data and settings set up similarly to the device previously assigned to the user. This may allow the user to quickly begin using the selected device without having to perform some setup actions (e.g., recovering data, installing frequently used applications) after receiving the selected device.

Method 200 also includes receiving a credential at a physical interface of the service kiosk at 240. The credential may be provided by the user. When the credential matches the authentication data associated with the user received at action 210, method 200 may provide physical access to compartments of the service kiosk at 250. For example, physical access may be provided to a first compartment into which the user is to store the first device, as well as a second compartment in which the selected device is stored so that the user can retrieve the selected device. Providing physical access to the compartments may be achieved by controlling locking mechanisms on the compartments. In some examples, after receiving the credential, the service kiosk may transmit the credential to a remote service. In this example, the remote service may perform authentication of the user, and subsequently transmit the data received by the kiosk at action 210.

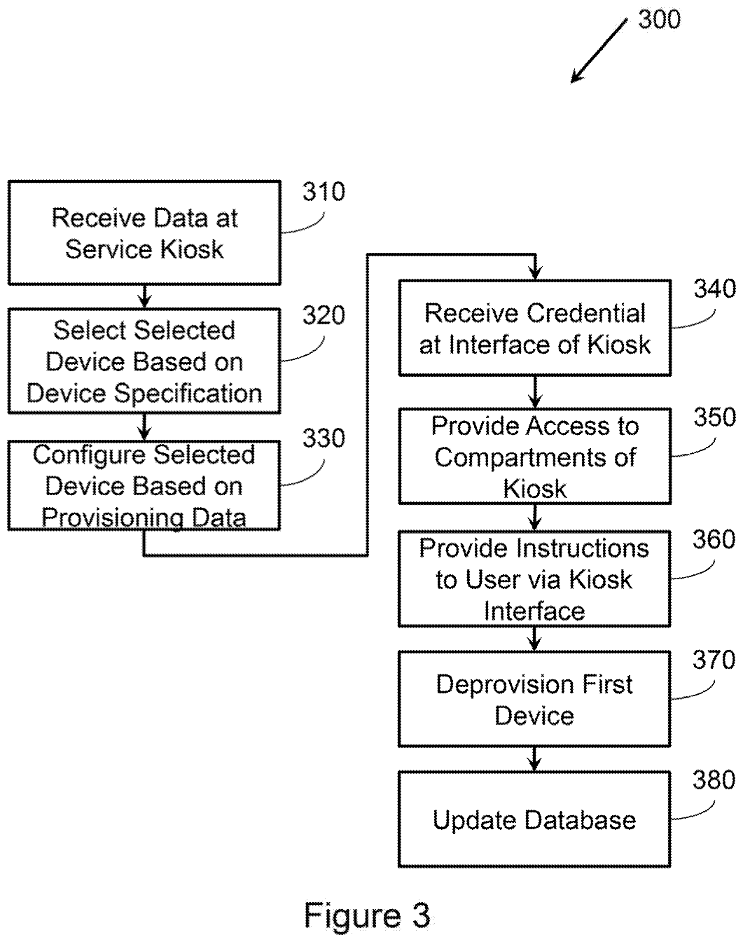

FIG. 3 illustrates a method 300 associated with service kiosk device provisioning. Method 300 includes several actions similar to those described above with reference to method 200 (FIG. 2 above). For example, method 300 includes receiving data at a service kiosk at 310, selecting a selected device based on the device specification at 320, configuring the selected device based on the provisioning data at 330, receiving a credential at an interface of the kiosk at 340, providing access to compartments of the kiosk at 350, and so forth.

Method 300 also includes providing instructions via an interface of the service kiosk to the user at 360. The instructions may guide the user regarding, for example, storing the first device in the first compartment, retrieving the selected device from the second compartment, performing an initial setup of the second device, and so forth. In various examples, the interface of the service kiosk may include a display, a keyboard, a keypad, indicators associated with the individual compartments, and so forth.

Method 300 also includes deprovisioning the first device at 370. Deprovisioning the first device may include, for example, securely removing data from the first device, uninstalling applications on the first device, restoring the first device to a prior state, and so forth. This may ensure that, for example, sensitive data on the first device is not removed in the event the first device is subsequently provisioned for use by another user.

Method 300 also includes updating a database at 380. The database may be updated to reflect that the user has taken possession of the selected device and is no longer in possession of the first device. In other examples, records may be updated associated with the first device to indicate the first device is no longer in possession of the user, and records associated with the selected device may be updated to indicate the selected device is in possession of the user. These records and/or database may be used by an employer of the user to track devices managed by a device-as-a-service infrastructure operated by the employer.

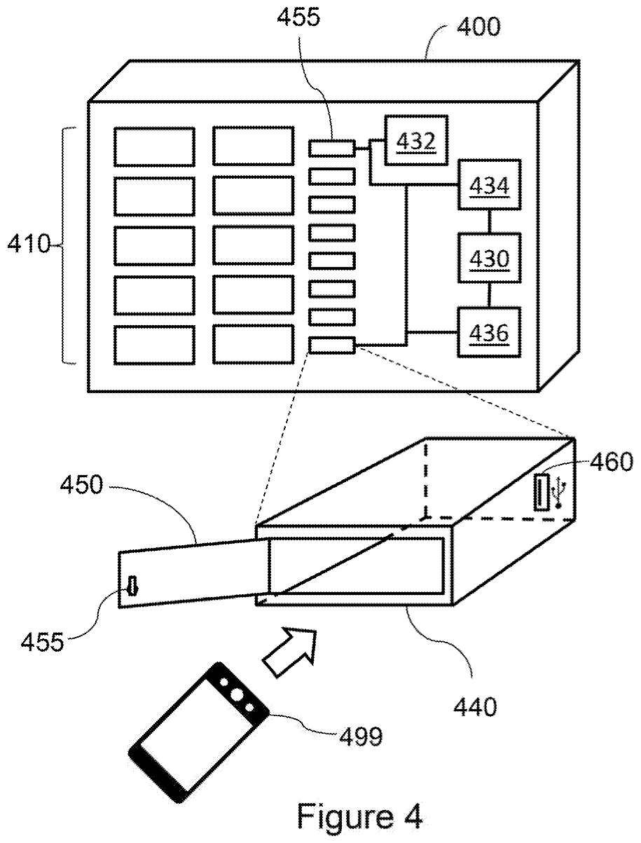

FIG. 4 illustrates an example service kiosk 400 associated with service kiosk provisioning. Service kiosk 400 includes a set of receptacles 410. An example receptacle 440 is illustrated in additional detail. Each member of the set of receptacles 410 may include an adaptor 460. Adaptor 460 may provide power to an electronic device 499, a data connection between electronic device 499 and components of service kiosk 400, and so forth. Members of the set of receptacles 410 may also include a locking mechanism 455 to secure the contents of the receptacles 410 (e.g., electronic device 499). In this example, locking mechanism 455 is attached to a door 450 of example receptacle 440. Here the locking mechanism may be able to rotate in a manner that prevents door 455 from opening.

Service kiosk 400 also includes a data receipt module 430. Data receipt module 430 may receive authentication data associated with a user, data associated with a first device 499 currently assigned to the user, a device specification for a second device to be provided to the user, and provisioning data for the second device.

Service kiosk 400 also includes a provisioning module 432. Provisioning module 432 may select a selected device to serve as the second device. The selected device may be stored in a selected receptacle 455 from set of receptacles 410. The selected device may be selected based on the device specification. Provisioning module 432 may also configure the selected device based on the provisioning data. The provisioning data may include, for example, applications to be installed on the second device, settings associated with the user, data retrieved from the first device, and so forth. Thus, configuring the second device may include installing the applications on the second device, applying the settings to the second device, storing the data retrieved from the first device to the second device, and so forth.

Service kiosk 400 also includes an authentication module 434. Authentication module 434 may authenticate a user based on a credential provided by the user and based on the authentication data associated with the user. Once authentication module 434 has authenticated the user, authentication module 434 may control a first locking member on a first locking mechanism of a first member (e.g., receptacle 450) of set of receptacles 410. This may grant the user access to receptacle 450. This may also allow the user to store first device 499 in receptacle 450. Authentication module may then control a selected locking mechanism of selected receptacle 455 to grant the user access to selected receptacle 455. This may allow the user to retrieve the selected device.

Service kiosk 400 also includes a decommission module 436. Decommission module 436 may decommission first device 499. Decommissioning first device 499 may include, for example, securely removing data from first device 499, uninstalling applications from first device 499, restoring first device 499 to a prior state, updating a database to note that the user is no longer in possession of first device 499, and so forth.

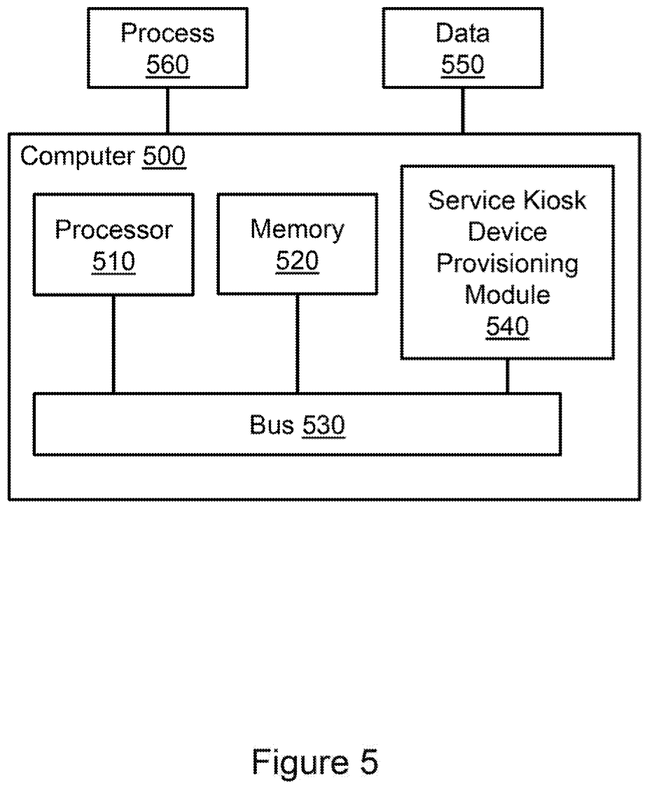

FIG. 5 illustrates an example computing device in which example systems and methods, and equivalents, may operate. The example computing device may be a computer 500 that includes a processor 510 and a memory 520 connected by a bus 530. Computer 500 includes a service kiosk device provisioning module 540. Service kiosk device provisioning module 540 may perform, alone or in combination, various functions described above with reference to the example systems, methods, and so forth. In different examples, service kiosk device provisioning module 540 may be implemented as a non-transitory computer-readable medium storing processor-executable instructions, in hardware, software, firmware, an application specific integrated circuit, and/or combinations thereof.

The instructions may also be presented to computer 500 as data 550 and/or process 560 that are temporarily stored in memory 520 and then executed by processor 510. The processor 510 may be a variety of processors including dual microprocessor and other multi-processor architectures. Memory 520 may include non-volatile memory (e.g., read-only memory, flash memory, memristor) and/or volatile memory (e.g., random access memory). Memory 520 may also be, for example, a magnetic disk drive, a solid state disk drive, a floppy disk drive, a tape drive, a flash memory card, an optical disk, and so on. Thus, memory 520 may store process 560 and/or data 550. Computer 500 may also be associated with other devices including other computers, devices, peripherals, and so forth in numerous configurations (not shown).

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A method, comprising:
receiving, at a service kiosk, authentication data associated with a user, data associated with a first device currently assigned to the user, a device specification for a second device to be provided to the user, and provisioning data for the second device;
selecting based on the device specification to serve as the second device, a selected member of a set of devices stored in compartments of the service kiosk and operably connected to the service kiosk;
configuring the selected device based on the provisioning data;
receiving at a physical interface of the service kiosk, a credential that matches the authentication data associated with the user;
providing physical access to a first compartment into which the user is to store the first device; and
providing physical access to a second compartment from which the user is to retrieve the selected device.

2. The method of claim 1, where the provisioning data includes applications to be installed on the second device, settings associated with the user, and data retrieved from the first device, and where configuring the selected device includes installing the applications on the selected device, applying the settings to the selected device, and storing the data retrieved from the first device to the selected device.

3. The method of claim 1, comprising deprovisioning the first device by at least one of securely removing data from the first device, uninstalling applications on the first device, and restoring the first device to a prior state.

4. The method of claim 1, where the authentication data, the data associated with the first device, the device specification for the second device, and the provisioning data are received by service kiosk in response to a device failure associated with the first device.

5. The method of claim 1, where the authentication data, the data associated with the first device, the device specification for the second device, and the provisioning data are received by the service kiosk in response to a life cycle event associated with the first device.

6. The method of claim 1, where providing physical access to the first compartment is achieved by controlling a locking mechanism on the first compartment.

7. The method of claim 1, comprising providing instructions via an interface of the service kiosk to the user regarding at least one of storing the first device in the first compartment, retrieving the selected device from the second compartment, and performing an initial setup of the selected device.

8. The method of claim 7, where the interface of the service kiosk includes a display, a keyboard, and indicators associated with the individual compartments.

9. The method of claim 1, comprising updating a database to reflect that the user has taken possession of the selected device and is no longer in possession of the first device.

10. A service kiosk, comprising:
a set of receptacles adapted to store electronic devices, each receptacle comprising:
an adaptor for providing at least one of power to an electronic device, and a data connection between the electronic device and the components of the service kiosk;
a locking mechanism to secure contents of the receptacle; and
a data receipt module to receive authentication data associated with a user, data associated with a first device currently assigned to the user, a device specification for a second device to be provided to the user, and provisioning data for the second device;
a provisioning module to select to serve as the second device a selected device stored in a selected receptacle from the set of receptacles, where the selected device is selected based on the device specification, and to configure the selected device based on the provisioning data;
an authentication module to authenticate a user based on a credential provided by the user and on the authentication data associated with the user, to control a first locking mechanism of a first member of the set of receptacles to grant the user access to the first member of the set of receptacles, allowing the user to store the first device in the first member of the set of receptacles, and to control a selected locking mechanism of the selected receptacle to grant the user access to the selected receptacle allowing the user to retrieve the selected device; and
a decommission module to decommission the first device.

11. The service kiosk of claim 10, where decommissioning the first device includes at least one of securely removing data from the first device, uninstalling applications on the first device, restoring the first device to a prior state, and updating a database to note that the user is no longer in possession of the first device.

12. The service kiosk of claim 10, where the provisioning data includes applications to be installed on the second device, settings associated with the user, and data retrieved from the first device, and where configuring the second device includes installing the applications on the second device, applying the settings to the second device and storing the data retrieved from the first device to the second device.

13. A non-transitory computer-readable medium storing processor executable instructions that, when executed, control a processor to:
receive, at a service kiosk, authentication data associated with user, data associated with a first device currently assigned to the user, a device specification for a second device to be provided to the user, and provisioning data for the second device;
select to serve as the second device based on the device specification, a selected device from a set of devices stored in receptacles of the service kiosk, the receptacles having independent operable connections between the service kiosk and the members of the set of devices, and locking mechanisms to secure the contents of the receptacles;
configure the selected device based on the provisioning data;
authenticate the user at a physical interface of the service kiosk based on a credential provided by the user that matches the authentication information;
control a locking mechanism on a first compartment of the service kiosk to grant access to the user to allow the user to connect the first device to an adaptor within the first compartment;
control the locking mechanism to restrict access to the first compartment upon detecting the first device has been connected to the adaptor;
control a locking mechanism on a selected receptacle storing the selected device to grant access to the user to allow the user to retrieve the selected device; and
deprovision the first device.

14. The non-transitory computer readable medium of claim 13, where the instructions further control the processor to update records associated with the first device to indicate the first device is no longer in possession of the user and to update records associated with the selected device to indicate the selected device is in possession of the user.

15. The non-transitory computer readable medium of claim 14, where the records are used by an employer of the user to track devices managed by a device-as-a-service infrastructure operated by the employer.
